(19) United States
(12) Patent Application Publication
(10) Pub. No.: US 2017/0265190 A1
(43) Pub. Date: Sep. 14, 2017

(54) METHOD, APPARATUS, AND COMPUTER PROGRAM PRODUCT FOR USER EQUIPMENT CAPABILITY INDICATION OF PARALLEL PROCESSING

(71) Applicant: Nokia Technologies Oy, Espoo (FI)

(72) Inventors: Pekka MARJELUND, Lohja (FI); Henrik LILJESTROM, Helsinki (FI)

(73) Assignee: Nokia Technologies Oy, Espoo (FI)

(21) Appl. No.: 15/066,267

(22) Filed: Mar. 10, 2016

(51) Int. Cl. H04W 72/04

(52) U.S. Cl. CPC H04W 72/0453; H04W 72/0413; H04W 72/048

(57) ABSTRACT

An example embodiment includes transmitting, by a wireless device, capability information to a network node, the capability information comprising parallel processing capability and maximum data throughput of the wireless device, to enable the network node to divide existing available link resources into a plurality of component bearer links for communication with the wireless device; and communicating, by the wireless device, with the network node via the plurality of component bearer links, at a level of data throughput up to the maximum data throughput indicated by the capability information.

### FIELD

The technology field relates to wireless wide-area networks, and more particularly to allocation of link resources in wide-area networks to maximize throughput of wireless connections to mobile devices.

### BACKGROUND

Modern society has adopted, and is becoming reliant upon, wireless communication devices for various purposes, such as, connecting users of the wireless communication devices with other users. Wireless communication devices can vary from battery powered handheld devices to stationary household and/or commercial devices utilizing electrical network as a power source. Due to rapid development of the wireless communication devices a number of areas capable of enabling entirely new types of communication applications have emerged.

The 5th generation (5G) wireless communications technology is expected to use high-frequency carriers of between 3 and 300 gigahertz (GHz), in the centimeter-wave (cmWave) band and millimeter-wave (mmWave) band, enabling the transmission of higher speed, higher-quality multimedia content. Cellular network architecture is expected to implement the cmWave/mmWave wireless communications technology, with implementations ranging in size from stationary base stations serving kilometer-sized cells, to portable base stations serving microcells, femtocells or picocells. The 5th generation (5G) wireless communication may operate on different radio bands including low frequency (<3 GHz) and high frequency cmWave and mmWave.

In 4th generation (4G) wireless communications technology, a wireless user equipment (UE) device may camp on any cell managed by a base station (eNB) and begins by synchronizing with the cell to acquire the physical cell ID (PCI), time slot and frame synchronization. After completing initial cell synchronization, the UE reads information blocks for the downlink channel bandwidth and cell access parameters, such as the base station eNB identity, Uplink physical channel configurations, Uplink power control, and Uplink carrier frequency and Bandwidth. The UE may then register with the eNB by transmitting an Attach Request to the eNB, which may include the UE's identity, authentication information, and capability information. The 5th generation (5G) wireless communications technology provides the feature of Dual Connectivity, which can significantly improve throughput and mobility. Dual Connectivity allows users to be connected simultaneously to a master cell group (MCG) via a master eNB (MeNB) and a secondary cell group (SCG) via a secondary eNB (SeNB). However, in both 4G and 5G technologies, UE device capability information provided to base stations includes only references to its maximum throughput and latency.

Since the 5th generation (5G) wireless communications technology enables very high throughput communication between the base station and the wireless device, the limited throughput of the existing transceiver pipeline and processing in wireless devices, may become a bottleneck for communication.

### SUMMARY

Method, apparatus, and computer program product example embodiments enable allocation of link resources in wide-area networks to maximize throughput of wireless connections to mobile devices.

An example embodiment of the invention includes a method comprising:

transmitting, by a wireless device, capability information to a network node, the capability information comprising parallel processing capability and maximum data throughput of the wireless device, to enable the network node to divide existing available link resources into a plurality of component bearer links for communication with the wireless device; and

communicating, by the wireless device, with the network node via the plurality of component bearer links, at a level of data throughput up to the maximum data throughput indicated by the capability information.

An example embodiment of the invention includes a method comprising:

wherein the capability information further comprises minimum latency of the wireless device; and

communicating, by the wireless device, with the network node via the plurality of component bearer links, at a level of latency down to the minimum latency indicated by the capability information.

An example embodiment of the invention includes a method comprising:

processing, by the wireless device, each component bearer link of the plurality of component bearer links, in a corresponding processor of a plurality of processors of the parallel processing capability of the wireless device, the parallel processing capability of the wireless device being required to meet a maximum bit rate and a minimum latency of the network node;

generating, by each corresponding processor of the plurality of processors, a corresponding data flow from processing a component bearer link of the plurality of component bearer links; and multiplexing, by the wireless device, the corresponding data flows generated by the plurality of processors, as a combined data flow to and from a baseband processor in the wireless device.

An example embodiment of the invention includes a method comprising:

wherein the maximum data throughput of the wireless device indicated in the capability information, is based on a maximum processing rate of the baseband processor in processing the combined data flow, and the minimum latency indicated in the capability information, is based on a minimum latency of the baseband processor in processing the combined data flow.

An example embodiment of the invention includes a method comprising:

wherein the processing of each component bearer link is performed for at least one of bit level, symbol level, subframe level, radio frame level, media access control (MAC) level, Radio Link Control (RLC) level, and Packet Data Convergence Protocol (PDCP) level processing.

An example embodiment of the invention includes a method comprising:

receiving, by a network node, capability information from a wireless device, the capability information comprising parallel processing capability and maximum data throughput of the wireless device, the parallel processing capability of the wireless device being required to meet a maximum bit rate of the network node;

dividing, by the network node, existing available link resources into a plurality of component bearer links for communication with the wireless device; and

communicating, by the network node, with the wireless device, via the plurality of component bearer links, at a level of data throughput up to the maximum data throughput indicated by the capability information.

An example embodiment of the invention includes a method comprising:

wherein the capability information further comprises minimum latency of the wireless device; and

communicating, by the network node, with the wireless device via the plurality of component bearer links, at a level of latency down to the minimum latency indicated by the capability information.

An example embodiment of the invention includes a method comprising:

wherein the plurality of component bearer links used for communication between the wireless device and the network node, is based on at least one of whether sufficient resources are available, the quality of service (QoS) required, and position of the wireless device with respect to the network node.

An example embodiment of the invention includes a method comprising:

wherein the network node is a cellular base station, which operates in both high frequency centimeter-wave (cmWave) and millimeter wave (mmWave) band and lower frequency band.

An example embodiment of the invention includes an apparatus comprising:

at least one processor;

at least one memory including computer program code;

the at least one memory and the computer program code configured to, with the at least one processor, cause the apparatus at least to:

transmit capability information to a network node, the capability information comprising parallel processing capability and maximum data throughput of the wireless device, to enable the network node to divide existing available link resources into a plurality of component bearer links for communication with the wireless device; and

communicate with the network node via the plurality of component bearer links, at a level of data throughput up to the maximum data throughput indicated by the capability information.

An example embodiment of the invention includes an apparatus comprising:

wherein the capability information further comprises minimum latency of the wireless device; and

the at least one memory and the computer program code configured to, with the at least one processor, cause the apparatus at least to:

communicate with the network node via the plurality of component bearer links, at a level of latency down to the minimum latency indicated by the capability information.

An example embodiment of the invention includes an apparatus comprising:

the at least one memory and the computer program code configured to, with the at least one processor, cause the apparatus at least to:

process each component bearer link of the plurality of component bearer links, in a corresponding processor of a plurality of processors of the parallel processing capability of the wireless device, the parallel processing capability of the wireless device being required to meet a maximum bit rate and a minimum latency of the network node;

generate by each corresponding processor of the plurality of processors, a corresponding data flow from processing a component bearer link of the plurality of component bearer links;

and multiplex the corresponding data flows generated by the plurality of processors, as a combined data flow to and from a baseband processor in the wireless device.

An example embodiment of the invention includes an apparatus comprising:

wherein the maximum data throughput of the wireless device indicated in the capability information, is based on a maximum processing rate of the baseband processor in processing the combined data flow, and the minimum latency indicated in the capability information, is based on a minimum latency of the baseband processor in processing the combined data flow.

An example embodiment of the invention includes an apparatus comprising:

wherein the processing of each component bearer link is performed for at least one of bit level, symbol level, subframe level, radio frame level, media access control (MAC) level, Radio Link Control (RLC) level, and Packet Data Convergence Protocol (PDCP) level processing.

An example embodiment of the invention includes an apparatus comprising:

at least one processor;

at least one memory including computer program code;

the at least one memory and the computer program code configured to, with the at least one processor, cause the apparatus at least to:

receive capability information from a wireless device, the capability information comprising parallel processing capability and maximum data throughput of the wireless device, the parallel processing capability of the wireless device being required to meet a maximum bit rate of the apparatus;

divide existing available link resources into a plurality of component bearer links for communication with the wireless device; and

communicate with the wireless device, via the plurality of component bearer links, at a level of data throughput up to the maximum data throughput indicated by the capability information.

An example embodiment of the invention includes an apparatus comprising:

wherein the capability information further comprises minimum latency of the wireless device; and

communicate with the wireless device via the plurality of component bearer links, at a level of latency down to the minimum latency indicated by the capability information.

An example embodiment of the invention includes an apparatus comprising:

wherein the plurality of component bearer links used for communication between the wireless device and the network node, is based on at least one of whether sufficient resources are available, the quality of service (QoS) required, and position of the wireless device with respect to the network node.

An example embodiment of the invention includes an apparatus comprising:

wherein the network node is a cellular base station, which operates in both high frequency centimeter-wave (cmWave) and millimeter wave (mmWave) band and lower frequency band.

An example embodiment of the invention includes a computer program product comprising computer executable program code recorded on a computer readable, non-transitory storage medium, the computer executable program code comprising:

code for transmitting, by a wireless device, capability information to a network node, the capability information comprising parallel processing capability and maximum data throughput of the wireless device, to enable the network node to divide existing available link resources into a plurality of component bearer links for communication with the wireless device; and code for communicating, by the wireless device, with the network node via the plurality of component bearer links, at a level of data throughput up to the maximum data throughput indicated by the capability information.

An example embodiment of the invention includes a computer program product comprising:

wherein the capability information further comprises minimum latency of the wireless device; and

code for communicating, by the wireless device, with the network node via the plurality of component bearer links, at a level of latency down to the minimum latency indicated by the capability information.

An example embodiment of the invention includes a computer program product comprising computer executable program code recorded on a computer readable, non-transitory storage medium, the computer executable program code comprising:

code for receiving, by a network node, capability information from a wireless device, the capability information comprising parallel processing capability, maximum data throughput of the wireless device, the parallel processing capability of the wireless device being required to meet a maximum bit rate of the network node;

dividing, by the network node, existing available link resources into a plurality of component bearer links for communication with the wireless device; and

communicating, by the network node, with the wireless device, via the plurality of component bearer links, at a level of data throughput up to the maximum data throughput indicated by the capability information.

An example embodiment of the invention includes a computer program product comprising:

wherein the capability information further comprises minimum latency of the wireless device; and

code for communicating, by the network node, with the wireless device via the plurality of component bearer links, at a level of latency down to the minimum latency indicated by the capability information.

### DESCRIPTION OF THE FIGURES

FIG. 1 illustrates a cellular network and functional block diagram of an example network node or base station eNB and user equipment wireless device UE located in a cell controlled by the base station eNB. Wireless device UE has a good mmWave line-of-sight to eNB and synchronizes and registers over the mmWave band radio link with the base station eNB. In accordance with an example embodiment of the invention, the wireless device UE, transmits capability information to the base station eNB, comprising parallel processing capability, maximum data throughput and minimum latency of the wireless device UE. The capability information enables the base station eNB to divide existing available link resources into a plurality of component bearer links for communication with the wireless device UE at a level of data throughput up to the maximum data throughput and a level of latency down to the minimum latency.

FIG. 2 is a functional block diagram of an example L1/L2 processing pipeline in the wireless device UE of FIG. 1, showing details of the computationally intensive L1/L2 protocol stack layer processing for one component bearer link of the plurality of component bearer links, in accordance with an example embodiment of the invention.

FIG. 3 is a cellular network and functional block diagram of the example base station eNB and wireless device UE of FIG. 1, showing details of the plurality of processing pipelines of the wireless device, each of which generates a corresponding data flow from processing a component bearer link of the plurality of component bearer links. The data flows are multiplexed as inputs to and outputs from a baseband processor in the wireless device, in accordance with the invention.

FIG. 4A is an example signal sequence diagram of the enquiry from the base station eNB for capability information from the wireless device UE and the responsive transfer of the capability information from the wireless device UE to the base station eNB, in accordance with the invention.

FIG. 4B is an example signal sequence diagram of the transfer of the capability information from the wireless device UE to the base station eNB, without a preceding enquiry from the base station eNB, in accordance with the invention.

FIG. 4C is an example format of the capability information 100 message, which may comprise parallel processing capability, maximum data throughput and minimum latency of the wireless device UE 120, in accordance with the invention.

FIG. 4D is an alternate example format of the capability information 100 message, which may comprise parallel processing capability and maximum data throughput of the wireless device UE 120, in accordance with the invention.

FIG. 5A is a flow diagram of an example programmed method executed by the wireless device UE, to transfer capability information to the base station eNB, in accordance with the invention.

FIG. 5B is a flow diagram of an example programmed method executed by the base station eNB, to receive the capability information from the wireless device UE, in accordance with the invention.

FIG. 6 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

### DISCUSSION OF EXAMPLE EMBODIMENTS OF THE INVENTION

In accordance with an example embodiment of the invention, the wireless device UE, transmits capability information to the base station eNB, comprising parallel processing capability, maximum data throughput and minimum latency of the wireless device UE. The capability information enables the base station eNB to divide existing available link resources into a plurality of component bearer links for communication with the wireless device UE at a level of data throughput up to the maximum data throughput and a level of latency down to the minimum latency.

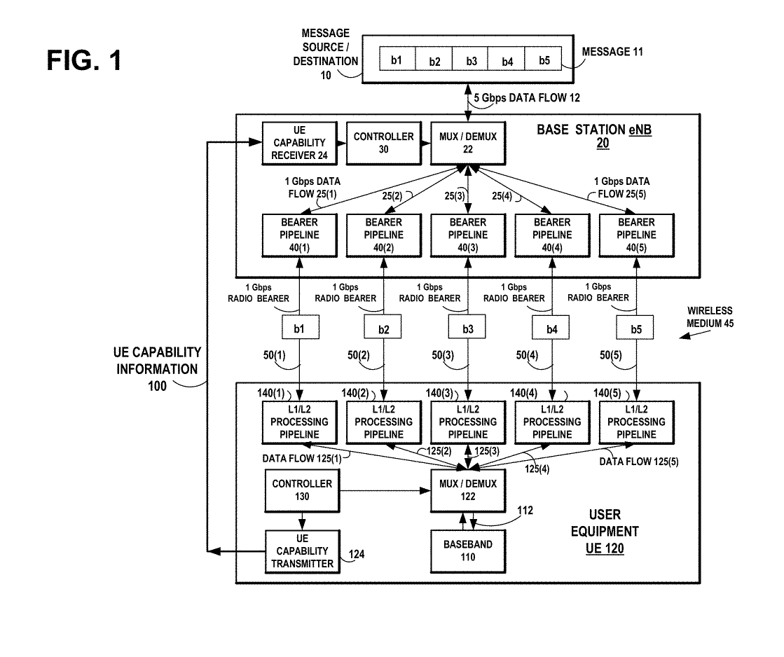

FIG. 1 illustrates a cellular network and functional block diagram of an example network node or base station eNB 20 and user equipment wireless device UE 120 located in a cell controlled by the base station eNB. The base station eNB is a cellular base station compatible with the 5th generation (5G) wireless communications technology, which operates in both high frequency centimeter-wave (cmWave) and millimeter wave (mmWave) band and lower frequency (<3 GHz) band. The wireless device UE 120 is also compatible with the 5th generation (5G) wireless communications technology, and operates in both high frequency centimeter-wave (cmWave) and millimeter wave (mmWave) band and lower frequency (<3 GHz) band. Example low frequency bands may include 700 MHz, 1700 MHz, 1900 MHz, or 2600 MHz bands.

Wireless device UE has a good mmWave line-of-sight to eNB and synchronizes and registers over the mmWave band radio link with the base station eNB. In accordance with an example embodiment of the invention, a UE capability transmitter 124 in the wireless device UE 120, wirelessly transmits capability information 100 to a UE capability receiver 24 in the base station eNB 20. The capability information 100 comprises parallel processing capability, maximum data throughput and minimum latency of the wireless device UE 120. The capability information enables the base station eNB to divide existing available link resources into a plurality of component bearer links 50(1), 50(2), 50(3), 50(4), and 50(5), for communication with the wireless device UE at a level of data throughput up to the maximum data throughput and a level of latency down to the minimum latency. The wireless device UE 120 is separately performs the computationally intensive L1/L2 protocol stack layer processing on each respective component bearer link. The very high throughput 5G communication may thus be processed by wireless device UE 120 without imposing a bottleneck on communication. The parallel processing capability of the wireless device UE 120, may be required to meet a maximum bit rate and a minimum time delay latency of the base station eNB 20.

For example, the parallel processing capability of the wireless device UE 120 is reported in the capability information 100 as five L1/L2 processing pipelines 140(1), 140(2), 140(3), 140(4), and 140(5). The maximum data throughput of the wireless device UE 120 is reported in the capability information 100 as 5 Gbps. The minimum latency of the wireless device UE 120 is reported in the capability information 100 as “Δt” nanoseconds. Then the base station eNB 20 is able to divide existing available link resources into a plurality of component bearer links 50(1), 50(2), 50(3), 50(4), and 50(5), for communication with the wireless device UE at a level of data throughput up to the maximum data throughput of 5 Gbps and a level of latency down to the minimum latency of “Δt” nanoseconds. The values given here for parallel processing capability, maximum data throughput and minimum latency of the wireless device UE 120 are only examples, which are used here for purposes of illustration. Other values may be used for parallel processing capability and maximum data throughput.

When the base station eNB 20 receives the capability information 100, it is programmed to consider whether sufficient resources are available, the quality of service (QoS) required, and the position of the wireless device UE 120 with respect to the network node. Based on these and other factors, the base station eNB 20 divides the existing available link resources into a plurality of component bearer links for communication with the wireless device UE 120. In the example shown in FIG. 1, the base station eNB 20 divides the existing available link resources into five component bearer links 50(1), 50(2), 50(3), 50(4), and 50(5), each being a 1 Gbps radio bearer. The base station eNB 20 then communicates with the wireless device UE 120, via the plurality of component bearer links 50(1), 50(2), 50(3), 50(4), and 50(5), at a level of data throughput of 5 Gbps.

For example, a message 11 that is divisible into five sequential message segments b1, b2, b3, b4, and b5, is received by the base station eNB 20 from a source 10, for transmission over the wireless medium 45 of the cellular network to the wireless device UE 120 at a data transmission rate of 5 Gbps. Based on the received capability information 100 from wireless device UE 120, the controller 30 in the base station eNB 20 controls the multiplexor/de-multiplexor 22 to divide the message 11 into the five sequential message segments b1, b2, b3, b4, and b5 and to deliver the message segments in five respective ones of 1 Gbps data flows 25(1), 25(2), 25(3), 25(4), and 25(5), to respective ones of five bearer pipelines 40(1), 40(2), 40(3), 40(4), and 40(5) in the base station eNB 20. The five message segments b1, b2, b3, b4, and b5 are then respectively transmitted via the five component radio bearer links 50(1), 50(2), 50(3), 50(4), and 50(5), each at a data rate of 1 Gbps, to the wireless device UE 120.

The wireless device UE 120 processes each component bearer link of the plurality of component bearer links 50(1), 50(2), 50(3), 50(4), and 50(5), in a corresponding processing pipeline of the plurality of L1/L2 processing pipelines 140(1), 140(2), 140(3), 140(4), and 140(5). The L1/L2 processing pipelines perform the computationally intensive L1/L2 protocol stack layer processing for each respective component bearer link of the plurality of component bearer links. The wireless device UE 120 generates with each corresponding L1/L2 processing pipeline, a corresponding data flow 125(1), 125(2), 125(3), 125(4), or 125(5), resulting from processing each component bearer link of the plurality of component bearer links. The controller 130 in the wireless device UE 120, controls the multiplexor/de-multiplexor 122 to multiplex the corresponding data flows generated by the plurality of processing pipelines, and to provide at 112, a combined data flow input to and output from a baseband processor 110 in the wireless device UE 120. In this manner, the very high throughput 5G communication may thus be processed by wireless device UE 120 without imposing a bottleneck on communication. The maximum data throughput of the wireless device UE 120 indicated in the capability information 100, is based on a maximum processing rate of the baseband processor 110 in processing the combined data flow 112, and the minimum latency indicated in the capability information 100, is based on a minimum latency of the baseband processor 110 in processing the combined data flow 112.

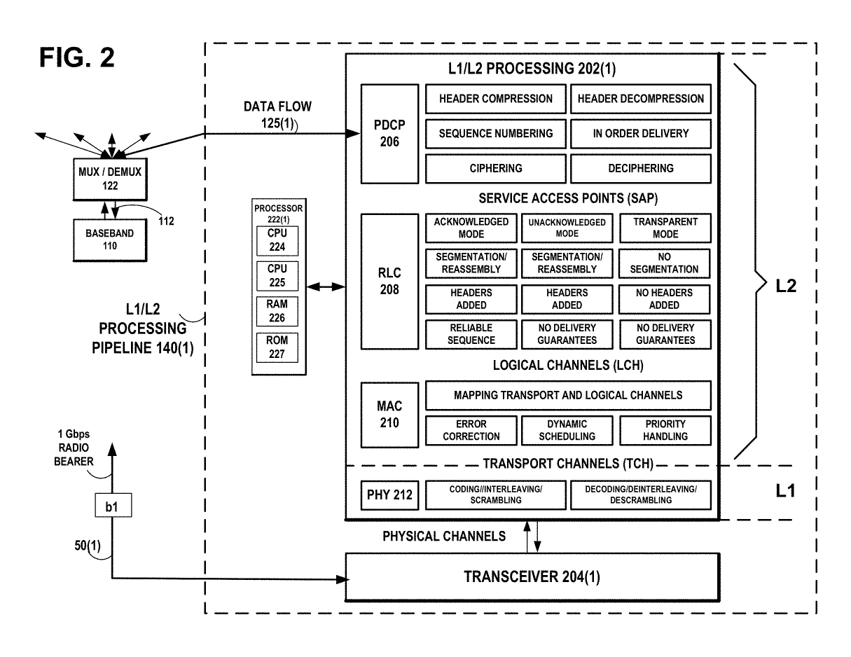

FIG. 2 is a functional block diagram of an example L1/L2 processing pipeline 140(1) in the wireless device UE 120 of FIG. 1, showing details of the computationally intensive L1/L2 protocol stack layer processing 202(1) for one component bearer link 50(1) of the plurality of component bearer links, in accordance with an example embodiment of the invention. The processing of the L1/L2 protocol stack layer for each component bearer link 50(1), 50(2), 50(3), 50(4), and 50(5), is performed for at least one of bit level, symbol level, subframe level, radio frame level, media access control (MAC) level, Radio Link Control (RLC) level, and Packet Data Convergence Protocol (PDCP) level processing. The component protocol functions of the L1 and L2 protocol stack layers are programmed instructions that may be stored in the random access memory (RAM) 126 and/or read only memory (ROM) 127, of the processor module 222(1). The dual core or multi-core CPUs 224 and 225 execute the programmed instructions to perform the functions of the L1 and L2 protocol stack layers. The L2 protocol stack layer includes Packet Data Convergence Protocol (PDCP) functions 206, Radio Link Control (RLC) functions 208, and Medium Access Control (MAC) functions 210. The L1 protocol stack layer includes channel coding, interleaving, and scrambling functions on the uplink and channel decoding, de-interleaving, and descrambling functions on the downlink. The transceiver 204(1) outputs or receives the physical channels on the component bearer link 50(1). By separately performing the computationally intensive L1/L2 protocol stack layer processing on each respective component bearer link, the very high throughput 5G communication may be processed without imposing a bottleneck on communication.

The processor module components may be embodied as hardware, firmware, or software. In an example embodiment of the invention, the wireless device UE 120 may also optionally include one or more of a key pad, touch screen, display, microphone, speakers, ear pieces, camera or other imaging devices, etc. The RAM and ROM may be removable memory devices, such as smart cards, SIMs, WIMs, semiconductor memories such as RAM, ROM, PROMS, flash memory devices, etc. The transceiver 204(1) of the wireless device UE 120 may use the cmWave and mmWave band and <3 GHz band for communication with the base station eNB 20.

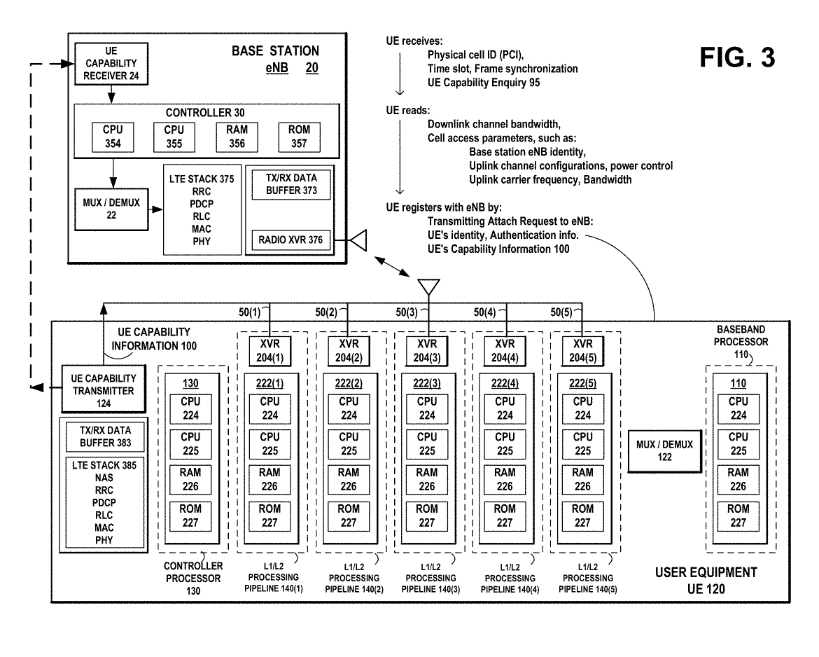

FIG. 3 is a cellular network and functional block diagram of the example base station eNB 20 and wireless device UE 120 of FIG. 1. The figure shows details of the plurality of the L1/L2 processing pipelines 140(1), 140(2), 140(3), 140(4), and 140(5) of the wireless device UE 120. Each of the L1/L2 processing pipelines generates a corresponding data flow (shown in FIG. 2), resulting from processing each component bearer link of the plurality of component bearer links 50(1), 50(2), 50(3), 50(4), and 50(5). The controller processor 130 in the wireless device UE 120, controls the multiplexor/de-multiplexor 122 to multiplex the corresponding data flows generated by the plurality of processing pipelines 140(1), 140(2), 140(3), 140(4), and 140(5), and to provide inputs to and outputs from the baseband processor 110 in the wireless device UE 120, in accordance with the invention.

The wireless device UE 120 includes transmit and receive data buffers TX/RX 383 and LTE stack 385. The components of the LTE stack 385 may include Non-access stratum (NAS), Radio Resource Control layer (RRC), Packet Data Convergence Protocol (PDCP), Radio Link Control (RLC), Medium Access Control (MAC), and PHY layers.

When the wireless device UE 120 wishes to camp on the base station eNB 20 cell, it begins by synchronizing with the cell to acquire the physical cell ID (PCI), time slot and frame synchronization. For cell synchronization, the wireless device UE 120 under the coverage of the base station eNB 20, may use the synchronization signal transmitted in the cmWave and mmWave band or the lower frequency (<3 GHz) band of the base station eNB 20. After completing initial cell synchronization, the wireless device UE 120 reads information blocks for the downlink channel bandwidth and cell access parameters, such as the base station eNB identity, Uplink physical channel configurations, Uplink power control, and Uplink carrier frequency and Bandwidth. The wireless device UE 120 may then register with the base station eNB 20 by transmitting an Attach Request to the eNB, which includes the UE's identity, authentication information, and the capability information 100. The UE may measure the Channel Quality Information of the cmWave and mmWave band signals or the lower frequency (<3 GHz) band signals from the base station eNB 20, indicating the channel quality and line-of-sight (LOS) propagation characteristics to the base station eNB 20.

The UE capability transmitter 124 in the wireless device UE 120, wirelessly transmits the capability information 100 to the UE capability receiver 24 in the base station eNB 20. The controller 30 in the base station eNB 20, is programmed to consider whether sufficient resources are available, the quality of service (QoS) required, and the position of the wireless device UE 120 with respect to the base station eNB 20. Based on these and other factors, the controller 30 controls the multiplexor/de-multiplexor 22 in the base station eNB 20, to divide the existing available link resources into the plurality of component bearer links for communication with the wireless device UE 120. The base station eNB 20 then communicates with the wireless device UE 120, via the plurality of component bearer links 50(1), 50(2), 50(3), 50(4), and 50(5), at up to the maximum data throughput of the wireless device UE 120 and a level of latency down to the minimum latency, which were reported in the capability information 100.

The base station eNB 20 includes programmed instructions that may be stored in the random access memory (RAM) 356 and/or read only memory (ROM) 357, of the controller 30. The dual core or multi-core CPUs 354 and 355 execute the programmed instructions to perform the functions of the base station eNB 20. The base station eNB 20 includes transmit and receive data buffers TX/RX 373 and LTE stack 375. The components of the LTE stack 375 may include Radio Resource Control layer (RRC), Packet Data Convergence Protocol (PDCP), Radio Link Control (RLC), Medium Access Control (MAC), and PHY layers. The base station eNB 20 includes the radio transceiver 376 for cmWave and mmWave band and <3 GHz band communication with the wireless device UE 120.

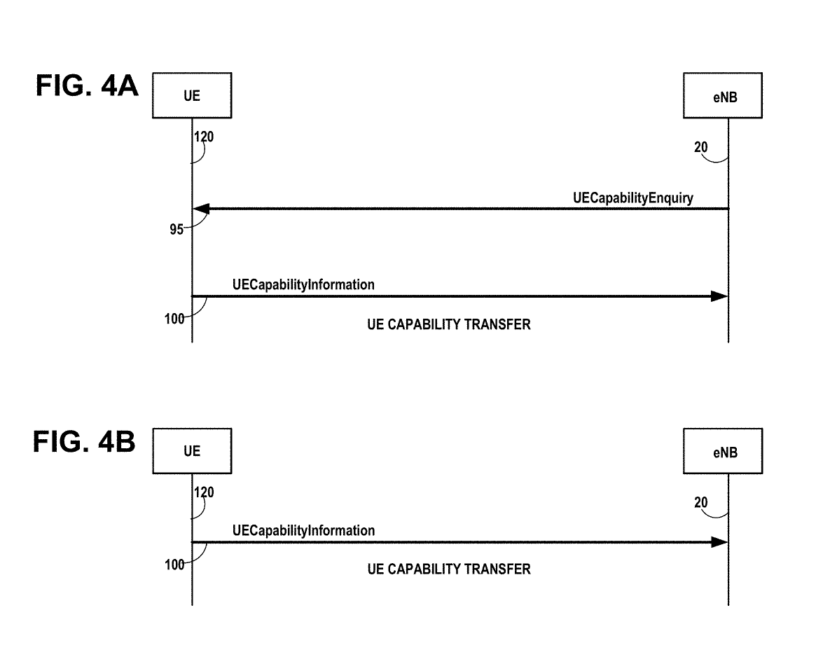

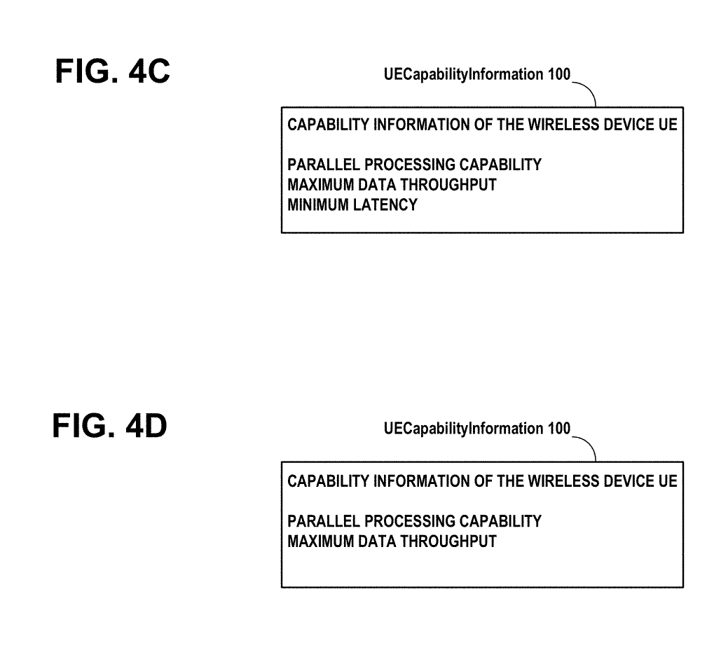

FIG. 4A is an example signal sequence diagram of the enquiry from the base station eNB for capability information from the wireless device UE and the responsive and the transfer of the capability information 100 from the wireless device UE 120 to the base station eNB 20, in accordance with the invention.

The sequence diagram of FIG. 4A shows:

Base station eNB 20 sending to wireless device UE 120, a UECapabilityEnquiry message 95.

Wireless device UE 120, in response, sending to base station eNB 20, a UECapabilityInformation message as the capability information 100.

FIG. 4B is an example signal sequence diagram of the transfer of the capability information 100 UECapabilityInformation from the wireless device UE 120 to the base station eNB 20, without a preceding enquiry UECapabilityInformation from the base station eNB, in accordance with the invention. The transfer by the wireless device UE 120 of the capability information 100 may be triggered by another type of condition or event.

FIG. 4C is an example format of the capability information 100 message, which may comprise the parallel processing capability, the maximum data throughput and the minimum latency of the wireless device UE 120. The capability information 100 may be a UECapabilityInformation message transmitted from the wireless device UE 120 to the base station eNB 20, in accordance with the invention.

FIG. 4D is an alternate example format of the capability information 100 message, which may comprise parallel processing capability and maximum data throughput of the wireless device UE 120, in accordance with the invention.

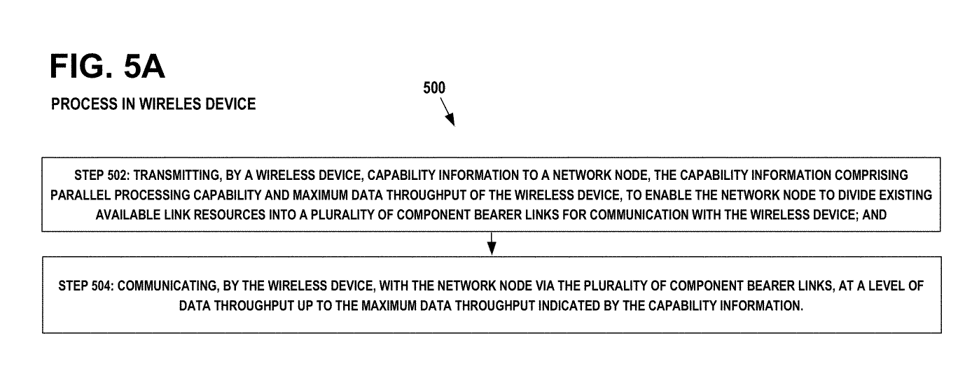

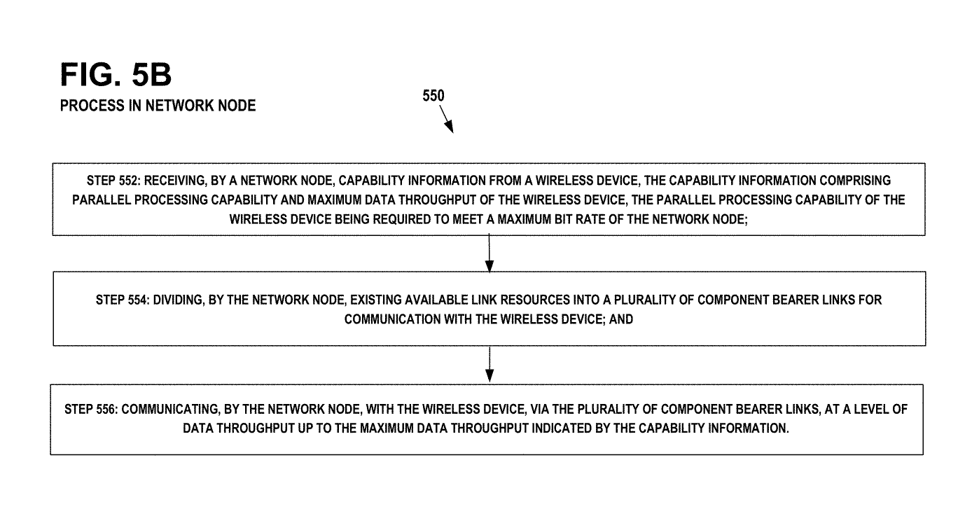

FIG. 5A is a flow diagram 500 of an example programmed method executed by the wireless device UE 120, to transfer capability information 100 to the base station eNB 20, in accordance with the invention, in accordance with the invention. The steps of the flow diagram represent computer code instructions stored in the RAM and/or ROM memory, which when executed by the central processing units (CPU), carry out the functions of the example embodiments of the invention. The steps may be carried out in another order than shown and individual steps may be combined or separated into component steps. The flow diagram has the following steps:

Step 502: transmitting, by a wireless device, capability information to a network node, the capability information comprising parallel processing capability and maximum data throughput of the wireless device, to enable the network node to divide existing available link resources into a plurality of component bearer links for communication with the wireless device; and

Step 504: communicating, by the wireless device, with the network node via the plurality of component bearer links, at a level of data throughput up to the maximum data throughput indicated by the capability information.

FIG. 5B is a flow diagram 550 of an example programmed method executed by the base station eNB 20, to receive the capability information 100 from the wireless device UE 120, in accordance with the invention. The steps of the flow diagram represent computer code instructions stored in the RAM and/or ROM memory, which when executed by the central processing units (CPU), carry out the functions of the example embodiments of the invention. The steps may be carried out in another order than shown and individual steps may be combined or separated into component steps. The flow diagram has the following steps:

Step 552: receiving, by a network node, capability information from a wireless device, the capability information comprising parallel processing capability and maximum data throughput of the wireless device, the parallel processing capability of the wireless device being required to meet a maximum bit rate of the network node;

Step 554: dividing, by the network node, existing available link resources into a plurality of component bearer links for communication with the wireless device; and

Step 556: communicating, by the network node, with the wireless device, via the plurality of component bearer links, at a level of data throughput up to the maximum data throughput indicated by the capability information.

In example embodiments of the invention, UE Capability Information 100 may be informed in several ways:

1. Dividing one end-to-end connection into several bearers that are combined in the wireless device UE 120 and network, into one connection after the computationally intense L1/L2 processing.

2. Alternatively, the combining and splitting may be done in the radio access network (RAN) level, such as only on the Packet Data Convergence Protocol (PDCP) level. This option provides parallel processing of the PDCP level, and may facilitate managing mobility cases and multiplexing over several 5G narrow bands or alternate radio access technologies (RATs).

Example embodiments of the invention, for bearer level parallel level processing:

The network will receive 5G wireless device UE 120 capability information 100 when the Radio Resource Control layer (RRC) Connection is setup or in case of mobility, the UE capability information 100 may be sent to the target cell. The central network is aware of the wireless device UE 120 capability all the time. The parallel processing capability may be handled as follows:
The central network setups needed bearers or corresponding data flows following the UE capability information 100. One bearer or corresponding data flow describes one parallel processing entity.
Radio access network (RAN) takes the UE capability information 100 into account when dividing or combining the data flows per component carriers based on:
   Resource status, is full throughput available;
   QoS, if full throughput needed;
   Mobility requirement, resource status in the target cell;
   UE position in the cell(s), can UE even use all processing.

In example embodiments of the invention, the parameters may be included in information elements including, for example:

Protocol level of parallel processing (bearer, data flow, PDCP, RLC);
Minimum number of parallel entities to meet required QoS (per level);
Maximum number of parallel entities to meet required QoS (per level).

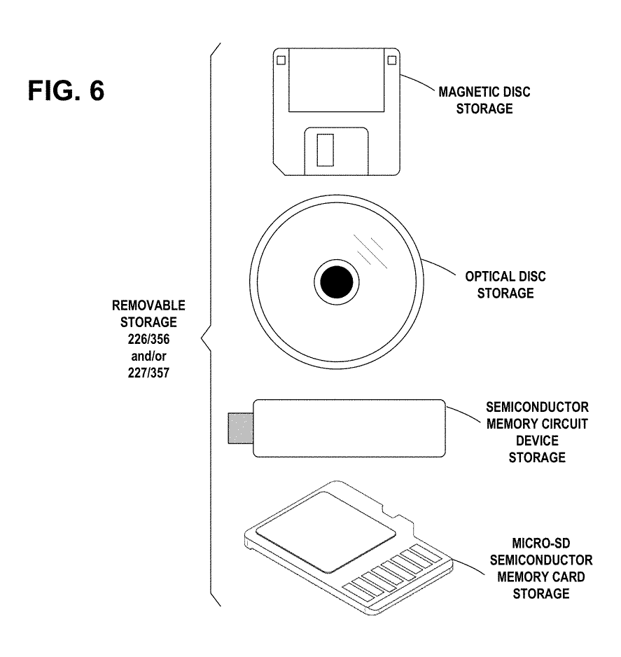

FIG. 6 illustrates an example embodiment of the invention, wherein examples of removable storage media are shown for RAM and/or ROM memories 226/356 and/or 227/357, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

Although two frequency bands, the low frequency band (<3 GHz) and high frequency band (cmWave and mmWave), are disclosed in example embodiments of the invention, it should be understood that example embodiments of the invention may operate in other frequency bands.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable non-transitory media such as resident memory devices, smart cards or other removable memory devices, thereby making a computer program product or article of manufacture according to the embodiments.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
transmitting, by a wireless device, capability information to a network node, the capability information comprising parallel processing capability and maximum data throughput of the wireless device, to enable the network node to divide existing available link resources into a plurality of component bearer links for communication with the wireless device; and
communicating, by the wireless device, with the network node via the plurality of component bearer links, at a level of data throughput up to the maximum data throughput indicated by the capability information.

2. The method of claim 1, further comprises:
wherein the capability information further comprises minimum latency of the wireless device; and
communicating, by the wireless device, with the network node via the plurality of component bearer links, at a level of latency down to the minimum latency indicated by the capability information.

3. The method of claim 2, further comprising:
processing, by the wireless device, each component bearer link of the plurality of component bearer links, in a corresponding processor of a plurality of processors of the parallel processing capability of the wireless device, the parallel processing capability of the wireless device being required to meet a maximum bit rate and a minimum latency of the network node;
generating, by each corresponding processor of the plurality of processors, a corresponding data flow from processing a component bearer link of the plurality of component bearer links; and
multiplexing, by the wireless device, the corresponding data flows generated by the plurality of processors, as a combined data flow to and from a baseband processor in the wireless device.

4. The method of claim 3, wherein the maximum data throughput of the wireless device indicated in the capability information, is based on a maximum processing rate of the baseband processor in processing the combined data flow, and the minimum latency indicated in the capability information, is based on a minimum latency of the baseband processor in processing the combined data flow.

5. The method of claim 4, wherein the processing of each component bearer link is performed for at least one of bit level, symbol level, subframe level, radio frame level, media access control (MAC) level, Radio Link Control (RLC) level, and Packet Data Convergence Protocol (PDCP) level processing.

6. A method, comprising:
receiving, by a network node, capability information from a wireless device, the capability information comprising parallel processing capability and maximum data throughput of the wireless device, the parallel processing capability of the wireless device being required to meet a maximum bit rate of the network node;
dividing, by the network node, existing available link resources into a plurality of component bearer links for communication with the wireless device; and
communicating, by the network node, with the wireless device, via the plurality of component bearer links, at a level of data throughput up to the maximum data throughput indicated by the capability information.

7. The method of claim 6, further comprises:
wherein the capability information further comprises minimum latency of the wireless device; and
communicating, by the network node, with the wireless device via the plurality of component bearer links, at a level of latency down to the minimum latency indicated by the capability information.

8. The method of claim 6, wherein the plurality of component bearer links used for communication between the wireless device and the network node, is based on at least one of whether sufficient resources are available, the quality of service (QoS) required, and position of the wireless device with respect to the network node.

9. The method of claim 6, wherein the network node is a cellular base station, which operates in both high frequency centimeter-wave (cmWave) and millimeter wave (mmWave) band and lower frequency band.

10. An apparatus, comprising:
at least one processor;
at least one memory including computer program code;
the at least one memory and the computer program code configured to, with the at least one processor, cause the apparatus at least to:
transmit capability information to a network node, the capability information comprising parallel processing capability and maximum data throughput of the wireless device, to enable the network node to divide existing available link resources into a plurality of component bearer links for communication with the wireless device; and
communicate with the network node via the plurality of component bearer links, at a level of data throughput up to the maximum data throughput indicated by the capability information.

11. The apparatus of claim 10, further comprises:
wherein the capability information further comprises minimum latency of the wireless device; and
the at least one memory and the computer program code configured to, with the at least one processor, cause the apparatus at least to:
communicate with the network node via the plurality of component bearer links, at a level of latency down to the minimum latency indicated by the capability information.

12. The apparatus of claim 11, further comprising:
the at least one memory and the computer program code configured to, with the at least one processor, cause the apparatus at least to:
process each component bearer link of the plurality of component bearer links, in a corresponding processor of a plurality of processors of the parallel processing capability of the wireless device, the parallel processing capability of the wireless device being required to meet a maximum bit rate and a minimum latency of the network node;
generate by each corresponding processor of the plurality of processors, a corresponding data flow from processing a component bearer link of the plurality of component bearer links; and
multiplex the corresponding data flows generated by the plurality of processors, as a combined data flow to and from a baseband processor in the wireless device.

13. The apparatus of claim 12, wherein the maximum data throughput of the wireless device indicated in the capability information, is based on a maximum processing rate of the baseband processor in processing the combined data flow, and the minimum latency indicated in the capability information, is based on a minimum latency of the baseband processor in processing the combined data flow.

14. The apparatus of claim 13, wherein the processing of each component bearer link is performed for at least one of bit level, symbol level, subframe level, radio frame level, media access control (MAC) level, Radio Link Control (RLC) level, and Packet Data Convergence Protocol (PDCP) level processing.

15. An apparatus, comprising:
at least one processor;
at least one memory including computer program code;
the at least one memory and the computer program code configured to, with the at least one processor, cause the apparatus at least to:
receive capability information from a wireless device, the capability information comprising parallel processing capability and maximum data throughput of the wireless device, the parallel processing capability of the wireless device being required to meet a maximum bit rate of the apparatus;
divide existing available link resources into a plurality of component bearer links for communication with the wireless device; and
communicate with the wireless device, via the plurality of component bearer links, at a level of data throughput up to the maximum data throughput indicated by the capability information.

16. The apparatus of claim 15, further comprises:
wherein the capability information further comprises minimum latency of the wireless device; and
communicate with the wireless device via the plurality of component bearer links, at a level of latency down to the minimum latency indicated by the capability information.

17. The apparatus of claim 15, wherein the plurality of component bearer links used for communication between the wireless device and the network node, is based on at least one of whether sufficient resources are available, the quality of service (QoS) required, and position of the wireless device with respect to the network node.

18. The apparatus of claim 15, wherein the network node is a cellular base station, which operates in both high frequency centimeter-wave (cmWave) and millimeter wave (mmWave) band and lower frequency band.

19. A computer program product comprising computer executable program code recorded on a computer readable, non-transitory storage medium, the computer executable program code comprising:
code for transmitting, by a wireless device, capability information to a network node, the capability information comprising parallel processing capability and maximum data throughput of the wireless device, to enable the network node to divide existing available link resources into a plurality of component bearer links for communication with the wireless device; and
code for communicating, by the wireless device, with the network node via the plurality of component bearer links, at a level of data throughput up to the maximum data throughput indicated by the capability information.

20. The computer program product of claim 19, further comprises:
wherein the capability information further comprises minimum latency of the wireless device; and
code for communicating, by the wireless device, with the network node via the plurality of component bearer links, at a level of latency down to the minimum latency indicated by the capability information.

21. A computer program product comprising computer executable program code recorded on a computer readable, non-transitory storage medium, the computer executable program code comprising:
code for receiving, by a network node, capability information from a wireless device, the capability information comprising parallel processing capability, maximum data throughput of the wireless device, the parallel processing capability of the wireless device being required to meet a maximum bit rate of the network node;
dividing, by the network node, existing available link resources into a plurality of component bearer links for communication with the wireless device; and
communicating, by the network node, with the wireless device, via the plurality of component bearer links, at a level of data throughput up to the maximum data throughput indicated by the capability information.

22. The computer program product of claim 21, further comprises:
wherein the capability information further comprises minimum latency of the wireless device; and
code for communicating, by the network node, with the wireless device via the plurality of component bearer links, at a level of latency down to the minimum latency indicated by the capability information.
